(19) United States
(12) Patent Application Publication
(10) Pub. No.: US 2006/0120690 A1
(43) Pub. Date: Jun. 8, 2006

(54) Method for offering selection point number to recording image and image reproducing apparatus thereof

(75) Inventor: Sung-youn Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/205,166

(22) Filed: Aug. 17, 2005

(30) Foreign Application Priority Data
Dec. 7, 2004 (KR) 2004-102356

(51) Int. Cl. H04N 5/91

(52) U.S. Cl. 386/95

(57) ABSTRACT

Provided are a method for offering a selection point number to a recording image and an image reproducing apparatus thereof. The method includes: respectively assigning selection point numbers to the selection points of the recorded image; and displaying information as to the selection points and the selection point numbers assigned to the selection points on an image to be reproduced.

### CROSS-REFERENCE TO RELATED APPLICATIONS

This application claims the benefit of Korean Patent Application No. 20046-102356 filed Dec. 7, 2004, in the Korean Intellectual Property Office, the disclosure of which is incorporated herein by reference.

### BACKGROUND OF THE INVENTION

1. Field of the Invention

The present invention relates to a method for offering a selection point number to a recording image and an image reproducing apparatus thereof. More particularly, the present invention relates to a method for offering information as to selection points of a recording image and selection point numbers assigned to the selection points and an image reproducing apparatus thereof.

2. Description of the Related Art

Image reproducing apparatuses operate to reproduce an image (hereinafter referred to as a recording image) recorded on a recording medium. A user can designate important points on a recording image or points on the recording image the user desires to replay later as selection points so as to search and/or reproduce the selection points more quickly and conveniently later. The image reproducing apparatuses also display information as to the designated selection points on a screen so as to offer the information to the user. This is widely known as a “bookmark” function.

FIG. 1A is a view illustrating a method of displaying bookmarks (a kind of selection points). As shown in FIG. 1A, bookmarks 15a, 15b, 15c, and 15d are displayed on a progress bar 10.

In a case where distances between the bookmarks 15a, 15b, 15c, and 15d on the progress bar 10 are reduced, the bookmarks 15a, 15b, 15c, and 15d may be displayed overlapping one another or it may be difficult to identify the bookmarks 15a, 15b, 15c, and 15d. This problem is shown in FIG. 1B.

A user can select one of the bookmarks 15a, 15b, 15c, and 15d shown in FIG. 1A to change a reproduction point into a point at which the selected bookmark is positioned. Here, the user can select one of the bookmarks 15a, 15b, 15c, and 15d by differently displaying colors of the bookmarks 15a, 15b, 15c, and 15d and using a remote controller with color keys respectively corresponding to the different colors. However, a number of color keys of the remote controller is limited, which results in limiting a number of bookmarks.

Also, as shown in FIG. 1A, the user is provided with only information as to a position point of a bookmark. In other words, the user cannot be provided with other types of information as to the bookmark.

### SUMMARY OF THE INVENTION

Accordingly, the present general inventive concept has been made to address the above-mentioned and/or problems, and an aspect of the present general inventive concept is to provide a method for offering information as to selection points of a recording image and selection point numbers so that a user can easily identify and conveniently manipulate the selection points and be provided with abundant information as to the selection points and an image reproducing apparatus thereof.

According to an aspect of the present invention, there is provided a method for offering selection point numbers to an image recorded on a recording medium, including: respectively assigning selection point numbers to the selection points of the recorded image; and overlapping information as to the selection points and the selection point numbers assigned to the selection points on an image to be reproduced.

The selection point numbers may be respectively assigned to the selection points based on temporal order of the selection points.

The method may further include: if a new selection point is added between existing selection points, assigning a selection point number to the new selection point based on temporal order of the existing selection points and the new selection point and adjusting selection point numbers assigned to the existing selection points.

Still images of the selection points as information as to the selection points may be overlapped as thumbnail images.

The method may further include: inputting a selection point number; and overlapping as information as to the selection points an image between an input point that is a selection point to which the input selection point number is assigned and a next point that is a selection point to which a selection point number next to the input selection point number is assigned as a thumbnail image.

Some still images of still images between the input point and the next point as the information as to the selection points may be alternately overlapped as thumbnail images.

Some still images of still images between the input point and the next point as the information as to the selection points may be alternately overlapped regardless of temporal order.

An image reproducing apparatus includes: a display information matching unit overlapping predetermined information on an image to be reproduced; and a controller controlling the display information matching unit to respectively assign selection point numbers to selection points of an image recorded on a recording medium and to overlap information as to the selection points and selection point numbers assigned to the selection points on the image to be reproduced.

The controller may respectively assign the selection point numbers to the selection points based on temporal order of the selection points.

If a new selection point is added between existing selection points, the controller may assign a selection point number to the new selection point and adjust the selection point numbers assigned to the existing selection points based on temporal order of the existing selection points and the new selection point.

The controller may control the display information matching unit to overlap still images of the selection points as information as to the selection points as thumbnail images.

The image reproducing apparatus may further include: a manipulator inputting a selection point number. Here, the controller may control the display information matching unit to overlap as information as to the selection point numbers an image between an input point that is a selection point to which the selection point number input via the manipulator is assigned and a next point that is a selection point to which a selection point number next to the input selection point number is assigned as a thumbnail image.

The controller may control the display information matching unit to alternately overlap some still images of still images between the input point and the next point as to the information as to the selection points as thumbnail images.

The controller may control the display information matching unit to alternately overlap some still images of still images between the input point and the next point as to the information as to the selection points as thumbnail images regardless of temporal order.

### BRIEF DESCRIPTION OF THE DRAWINGS

The above aspects and features of the present invention will be more apparent by describing certain embodiments of the present invention with reference to the accompanying drawings, in which:

FIGS. 1A and 1B are views illustrating a method of displaying bookmarks;

FIG. 2 is a block diagram of an image reproducing apparatus according to an exemplary embodiment of the present invention;

FIG. 3 is a flowchart of a method for offering selection point numbers to a recording image according to an exemplary embodiment of the present invention;

FIG. 4A is a view showing a display on which information as to four selection points and selection point numbers are displayed;

FIG. 4B is a view showing a display on which information as to N selection points and selection point numbers are displayed;

FIG. 4C is a view illustrating a method of overlapping detailed information as to selection points; and

FIG. 4D is a view illustrating a method of assigning a selection number to an additionally requested selection point and adjusting selection point numbers assigned to existing selection points.

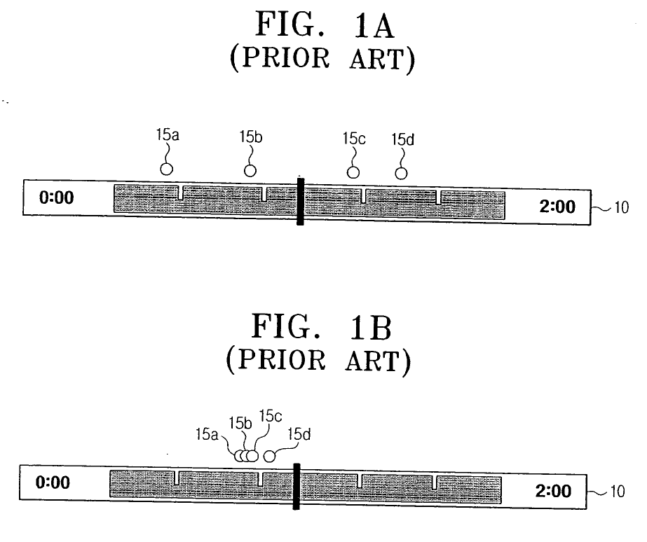

### DETAILED DESCRIPTION OF THE EXEMPLARY EMBODIMENTS

Certain embodiments of the present invention will be described in greater detail with reference to the accompanying drawings.

In the following description, the same drawing reference numerals are used for the same elements even in different drawings. Certain descriptions, such as detailed descriptions of construction and elements, are merely provided to assist in a comprehensive understanding of the invention. Thus, it is apparent that the present invention can be carried out without the particular details described. Also, well-known functions or constructions are not described in detail since they would obscure the invention in unnecessary detail.

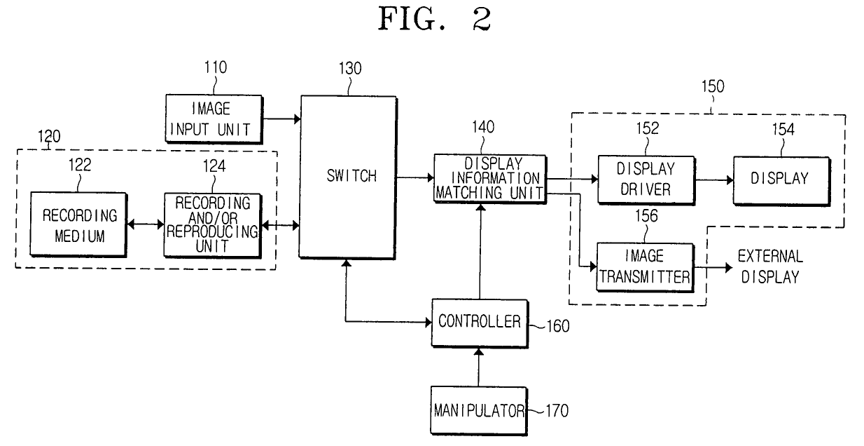

FIG. 2 is a block diagram of an image reproducing apparatus according to an embodiment of the present invention. The image reproducing apparatus of the present invention is an apparatus reproducing an image (hereinafter referred to as a recording image) recorded on a recording medium. A user can select an important point or a point the user desires to replay later using the image reproducing apparatus of the present invention. The image reproducing apparatus serves to overlap information as to points (hereinafter referred to as selection points) selected by the user on a recording image to be reproduced so as to offer the information as to the selection points to the user. The image reproducing apparatus of the present invention may respectively assign selection point numbers to the selection points so as to offer the information as to the selection points together with the selection point numbers.

Referring to FIG. 2, the image reproducing apparatus of the present invention includes an image input unit 110, an image recording and/or reproducing unit 120, a switch 130, a display information matching unit 140, an image output unit 150, a controller 160, and a manipulator 170.

The image input unit 110 applies an image (hereinafter referred to as an input image) input from an external source to the switch 130. In detail, the image input unit 110 processes (hereinafter referred to as “reproducible process”) a broadcast selected through a tuner or an image received from an external device, for example, an external settop box, an external TV, or the like, so as to be reproduced and then applies the processed broadcast or image to the switch 130.

The image recording and/or reproducing unit 120 records the input image and/or reproduces the recorded image and includes a recording medium 122 and a recording and/or reproducing unit 124. In detail, the recording and/or reproducing unit 124 records the input image applied through the switch 130 from the image input unit 110 on a recording medium 122. The recording and/or reproducing unit 124 also reads the recording image from the recording medium 122 and applies the read recording image to the switch 130.

The switch 130 performs a switching operation so that the image applied from the image input unit 110 and the image recording and reproducing unit 120 is selectively output to the display information matching unit 140 or the input image applied from the image input unit 110 is output to the image recording and/or reproducing unit 120. The switching operation of the switch 130 is controlled by the controller 160 that will be described later.

The display information matching unit 140 overlaps predetermined information on the image output from the switch 130, i.e., the image to be reproduced. In detail, overlapping the predetermined information is achieved as follows: i) the controller 160 controls the display information matching unit 140 to overlap information that a user desires to obtain or that is useful to the user on the image to be reproduced; and ii) the display information matching unit 140 is controlled by the controller 160 to overlap corresponding information on the image to be reproduced.

The display information matching unit 140 may overlap the corresponding information on the image to be reproduced according to an on-screen display (OSD) method or a graphical user interface method.

The image output unit 150 outputs the image output from the display information matching unit 140, i.e., the image on which the corresponding information is overlapped, to an internal or external display. In detail, a display driver 152 displays the image on a display 154 so as to achieve the output of the image to the internal display, and an image transmitter 156 transmits the image to the external display so as to achieve the output of the image to the external display.

The controller 160 controls the overall operation of the image reproducing apparatus of the present invention according to a manipulation command transmitted through a manipulator 170 from a user. In particular, the controller 160 controls the display information matching unit 140 so as to overlap information as to selection points on the image to be reproduced. The controller 160 also assigns selection point numbers to the selection points and controls the display information matching unit 140 so as to overlap the selection point numbers together with the information as to the selection points.

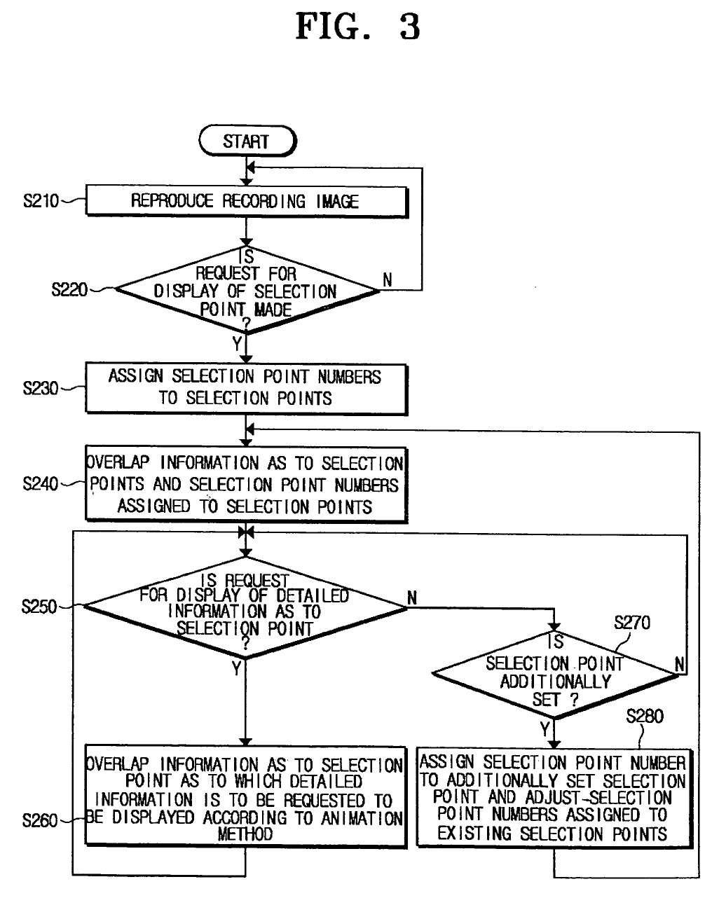

A process of overlapping the selection point numbers with the information as to the selection points on the image to be reproduced will now be described in detail with reference to FIG. 3. Here, it is supposed that the selection points are predetermined by a user.

In operation S210, the image reproducing apparatus of the present invention reproduces the recording image. In detail, in operation S210, the image output unit 150 outputs the recording image reproduced by the image recording and/or reproducing unit 120.

In operation S220, the controller 160 determines during operation S210, i.e., during reproduction of the recording image, whether a request for a display of a selection point is input. The request for the display of the selection point may be input through a manipulation key provided on the manipulator 170 from the user. Since the request for the display of the selection point input through the manipulator 170 from the user is transmitted to the controller 160, the controller 160 may determine whether the request for the display of the selection point is input.

If the controller 160 determines in operation S220 that the request for the display of the selection point is input, in operation S230, the controller 160 respectively assigns the selection point numbers to the selection points based on temporal order of the selection points. In other words, the controller 160 assigns a previous selection point number to a previous selection point and a subsequent selection point number to a subsequent selection point according to the temporal order.

In operation S240, the controller 160 controls the display information matching unit 140 to overlap the information as to the selection points together with the selection point numbers assigned to the selection points on the recording image to be reproduced. Here, the reproduction of the recording image may pause.

In operation S240, the controller 160 may control the display information matching unit 140 so as to overlap still images of the selection points as the information as to the selection points as thumbnail images. For this purpose, the controller 160 must draw up the still images of the selection points as the thumbnail images in advance and store the thumbnail images in a memory provided inside the display information matching unit 140 in advance. This is executed to achieve overlapping performed in operation S240 at a higher speed.

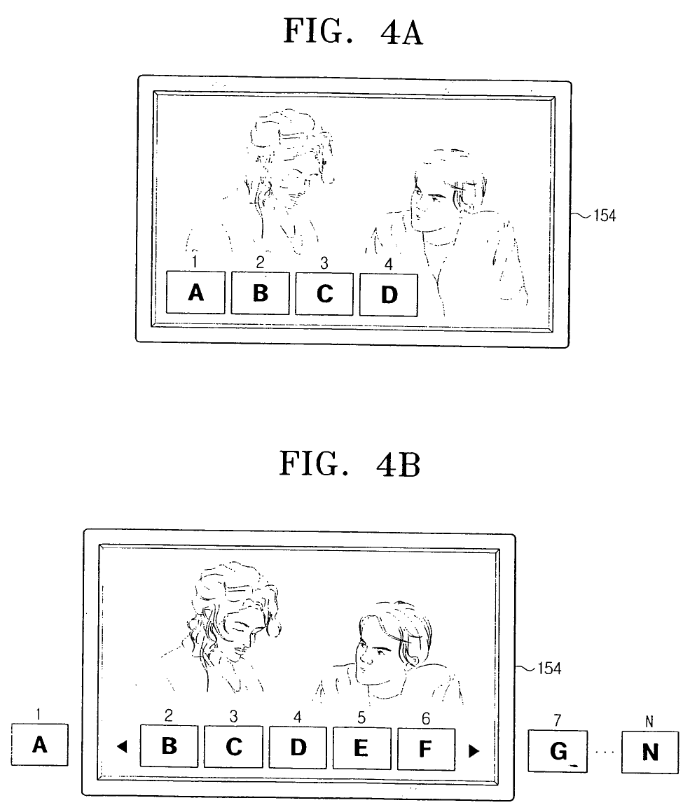

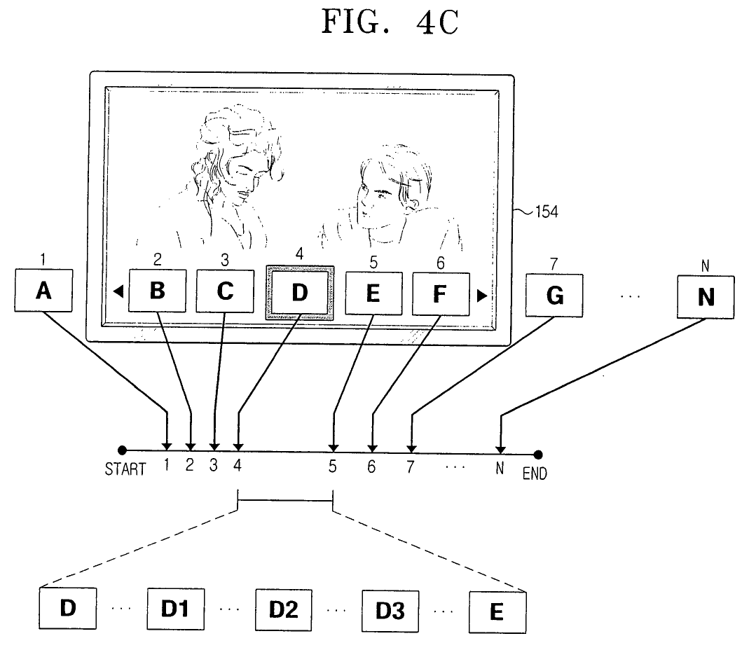

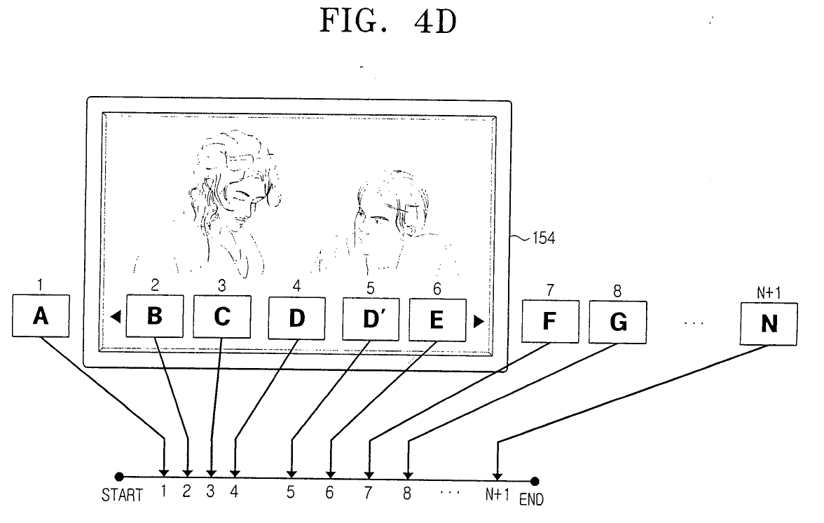

FIG. 4A shows a display 154 on which information as to four selection points and selection point numbers are displayed. As shown in FIG. 4A, still images “A,” “B,” “C,” and “D” of first through fourth selection points as information as to the first through fourth selection points are displayed as thumbnail images at a lower portion of the display 154. However, for the convenience of drawing of a figure and understanding, the still images of the selection points are displayed using characters “A,” “B,” “C,” and “D” not substantial images.

As shown in FIG. 4A, selection point numbers “1” “2,” “3,” and “4” are displayed above the information as to the first through fourth selection points.

FIG. 4B shows a display 154 on which information as to N (>5) selection points and selection point numbers are displayed. Due to a limit to a number of thumbnail images (a number of thumbnail images on the display 154 shown in FIG. 4B is limited to five) displayable at a lower portion of the display 154, only information as to five selection points, i.e., second through sixth selection points, is displayed on the display 154. Signs “ [symbol] ” and “ [symbol] ” are also displayed to indicate that in addition to the five selection points, selection points further exist. Even in this case, selection point numbers “2,” “3,” “4,” “5,” and “6” are displayed above information as to the displayed second through sixth selection points.

After operation S240, the user may make a request for a display of detailed information as to a specific one of existing selection points or additionally set a new selection point.

If the controller 160 determines in operation S250 that the user makes the request for the detailed information as to the selection point, in operation S260, the controller 160 controls the display information matching unit 140 to overlap information as to the selection point as to which the user makes the request for the detailed information according to an animation method.

To perform operation S250, the user may input a selection point number assigned to a selection point as to which detailed information is to be requested to be displayed, using a number key provided on the manipulator 170. Alternatively, the user may designate the selection point as to which the detailed information is to be requested to be displayed, using direction and selection keys provided on the manipulator 170.

Overlapping according to the animation method in operation S260 may be achieved by overlapping an image between a selection point (hereinafter referred to as an input point) to which an input selection point number is assigned and a selection point (hereinafter referred to as a next point) to which a selection point number next to the input selection point number is assigned as a thumbnail image.

In detail, operation S260 may be embodied by alternately overlapping some of the still images between the input point and the next point as thumbnail images.

Operation S260 will now be amplified with reference to FIG. 4C. FIG. 4C is a view illustrating a method of overlapping detailed information as to a selection point.

If the user makes a request for a display of detailed information as to the fourth selection point in operation S250, i.e., the user inputs the selection point number “4”, still images “D,” “D1,” “D2,” “D3,” and “E” of still images existing between the fourth selection point (the input point) and the fifth selection point (the next point) are alternately displayed as thumbnail images on the information as to the fourth selection point.

Here, the still images “D,” “D1,” “D2,” “D3,” and “E” displayed as the thumbnail images may be alternately displayed in temporal order or may be alternately displayed regardless of the temporal order, i.e., randomly.

If the user additionally sets a new selection point in operation S270, in operation S280, the controller 160 assigns a selection point number to the additionally set selection point and adjusts selection point numbers assigned to existing selection points based on temporal order of the existing selection points and the additionally set selection point. Thereafter, operation S240 is performed to overlap information as to the additionally set selection point and the adjusted selection point numbers on the recording image to be reproduced.

For the amplification of this, FIG. 4D shows results of performing operations S280 and S240 when the new selection point is additionally set between the fourth and fifth selection points shown in FIG. 4C. Referring to FIG. 4D, since the temporal order of the additionally set selection point is immediately after the fourth selection point, “5” is assigned as a selection point number of the additionally set selection point. Also, the still image D′ of the additionally set selection point as information as to the additionally set selection point is displayed as a thumbnail image. In addition, selection point numbers “5,” “6,” “7,” . . . , and “N” (refer to FIG. 4C) assigned to the fifth, sixth, seventh, . . . , and Nth selection points are respectively adjusted as “6,” “7,” “8,” . . . , and “N+1” (refer to FIG. 4D).

There has been described a method of overlapping information as to selection points together with selection point numbers on an image to be reproduced. According to the method, the information as to the selection points is displayed together with the selection point numbers. Thus, the user can select the selection point numbers to change (jump) to a desired reproduction point.

In the present invention, in a case where a recording image is reproduced, selection point numbers are assigned to selection points of the recording image and the assigned selection point numbers are additionally displayed. However, this is only for the convenience of explanation. Even in a case of a Time-Shift reproduction method by which a predetermined quantity of broadcast content is stored in a First-In First-Out (FIFO) manner and then a specific time point of the stored broadcast is reproduced, selection point numbers may be assigned to selection points of the stored broadcast and the assigned selection point numbers may be additionally displayed.

As described above, in a method for offering selection point numbers to a recording image and an image reproducing apparatus thereof, according to the present invention, besides information as to selection points, selection point numbers are additionally provided. Thus, a user can more conveniently input a selection point the user desires to reproduce using a number key. Also, since still images of the selection points as the information as to the selection points are displayed as thumbnail images, the selection points can be easily identified without being overlapped. Moreover, the information as to the selection points can be displayed by animation to offer more detailed information as to the selection points. Furthermore, a conventional method of differently displaying colors of selection points is not adopted. Thus, the number of selection points is not limited.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for offering selection point numbers to an image recorded on a recording medium, comprising:
respectively assigning selection point numbers to selection points of the recorded image; and
overlapping information as to the selection points and the selection point numbers assigned to the selection points on an image to be reproduced.

2. The method of claim 1, wherein the selection point numbers are respectively assigned to the selection points based on temporal order of the selection points.

3. The method of claim 2, further comprising:
if a new selection point is added between existing selection points, assigning a selection point number to the new selection point based on temporal order of the existing selection points and the new selection point and adjusting selection point numbers assigned to the existing selection points.

4. The method of claim 1, wherein still images of the selection points as information as to the selection points are overlapped as thumbnail images.

5. The method of claim 4, further comprising:
inputting a selection point number; and
overlapping as information as to the selection points an image between an input point that is a selection point to which the input selection point number is assigned and a next point that is a selection point to which a selection point number next to the input selection point number is assigned as a thumbnail image.

6. The method of claim 5, wherein some still images of still images between the input point and the next point as the information as to the selection points are alternately overlapped as thumbnail images.

7. The method of claim 5, wherein some still images of still images between the input point and the next point as the information as to the selection points are alternately overlapped regardless of temporal order.

8. An image reproducing apparatus comprising:
a display information matching unit that overlaps predetermined information on an image to be reproduced; and
a controller that controls the display information matching unit to respectively assign selection point numbers to selection points of an image recorded on a recording medium and to overlap information as to the selection points and selection point numbers assigned to the selection points on the image to be reproduced.

9. The image reproducing apparatus of claim 8, wherein the controller respectively assigns the selection point numbers to the selection points based on temporal order of the selection points.

10. The image reproducing apparatus of claim 9, wherein if a new selection point is added between existing selection points, the controller assigns a selection point number to the new selection point and adjusts the selection point numbers assigned to the existing selection points based on temporal order of the existing selection points and the new selection point.

11. The image reproducing apparatus of claim 8, wherein the controller controls the display information matching unit to overlap still images of the selection points as information as to the selection points as thumbnail images.

12. The image reproducing apparatus of claim 11, further comprising:
a manipulator inputting a selection point number,
wherein the controller controls the display information matching unit to overlap as information as to the selection point numbers an image between an input point that is a selection point to which the selection point number input via the manipulator is assigned and a next point that is a selection point to which a selection point number next to the input selection point number is assigned as a thumbnail image.

13. The image reproducing apparatus of claim 12, wherein the controller controls the display information matching unit to alternately overlap some still images of still images between the input point and the next point as to the information as to the selection points as thumbnail images.

14. The image reproducing apparatus of claim 12, wherein the controller controls the display information matching unit to alternately overlap some still images of still images between the input point and the next point as to the information as to the selection points as thumbnail images regardless of temporal order.
